(19) United States
(12) Patent Application Publication
(10) Pub. No.: US 2008/0167808 A1
(43) Pub. Date: Jul. 10, 2008

(54) Method for Displaying Leakage Location and Leakage Magnitude

(76) Inventors: James E. Harris, Indianapolis, IN (US); Raleigh B. Stelle, Indianapolis, IN (US)

Correspondence Address: BARNES & THORNBURG LLP, 11 SOUTH MERIDIAN, INDIANAPOLIS, IN, 46204, US

(21) Appl. No.: 11/955,134

(22) Filed: Dec. 12, 2007

Related U.S. Application Data
(60) Provisional application No. 60/878,918, filed on Jan. 5, 2007.

(51) Int. Cl. G01C 21/30

(52) U.S. Cl. 701/208

(57) ABSTRACT

A method for displaying leakage location and leakage magnitude comprising displaying at least one of an aerial map and a hybrid street/aerial map on a display, displaying on the map icons to indicate where leakage above a certain, user-selectable threshold has been detected, and indicating by a characteristic of the icons selected levels of leakage magnitude.

### CROSS REFERENCE TO RELATED APPLICATIONS

This regular utility patent application claims the benefit of the filing date of U.S. Ser. No. 60/878,918, titled “Leakage Location Detection Method,” filed Jan. 5, 2007. U.S. Ser. No. 60/878,918 is a related application to U.S. Ser. No. 60/861,164, filed Nov. 27, 2006, titled “Leakage Testing Method and Apparatus,” U.S. Ser. No. 11/943,950, filed Nov. 21, 2007, titled “Leakage Testing Method and Apparatus,” U.S. Ser. No. 11/742,184, titled “Leakage Location Methods,” filed Apr. 30, 2007, and U.S. Ser. No. 60/836,036, titled “Leakage Location Method,” filed Aug. 7, 2006. The complete disclosures of U.S. Ser. No. 60/878,918, U.S. Ser. No. 11/943,950, U.S. Ser. No. 60/836,036, U.S. Ser. No. 60/861,164 and U.S. Ser. No. 11/742,184 are incorporated herein by reference.

### FIELD OF THE INVENTION

This invention relates to apparatus for displaying records concerning leakage from, for example, CATV cables, taps, fittings, drops and other CATV plant facilities, but it is believed to be useful in other applications as well.

### DISCLOSURE OF THE INVENTION

According to an aspect of the invention, a method is provided for displaying leakage location and leakage magnitude. The method comprises displaying at least one of an aerial map and a hybrid street/aerial map on a display, displaying on the map icons to indicate where leakage above a certain, user-selectable threshold has been detected, and indicating by a characteristic of the icons selected levels of leakage magnitude.

Illustratively, the method further includes establishing the selected levels of leakage magnitude.

Illustratively, the method further includes making leakage measurements and uploading the leakage measurements into a server to which the operator viewing the display has access.

Illustratively, the method further includes placing a cursor associated with the display over a selected icon and displaying a balloon including information concerning the leak which is the subject of the icon.

Illustratively, the method further includes providing on the display a table of variables, and placing a cursor associated with the display over a selected icon and displaying a balloon including information includes displaying a balloon including a leak number. The table includes the leak number and variables associated with the numbered leak.

Illustratively, the method further includes providing a widget for permitting an operator to generate a work order to repair the leak represented by the selected icon. The work order number is one of the variables included in the table.

Illustratively, displaying a map on a display comprises providing a widget for permitting an operator to select a map from among a street map, an aerial map, and a hybrid street/aerial map.

Illustratively, the method further includes providing a widget for permitting an operator to generate a work order to repair the leak represented by the selected icon.

### BRIEF DESCRIPTION OF THE DRAWINGS

The invention may best be understood by referring to the following detailed description and accompanying drawings which illustrate the invention. In the drawings:

FIGS. 1-3 illustrate screen shots containing street maps useful in understanding the invention;

FIGS. 4-6 illustrate screen shots containing aerial maps useful in understanding the invention; and,

FIGS. 7-9 illustrate screen shots containing hybrid street/aerial maps useful in understanding the invention.

### DETAILED DESCRIPTIONS OF ILLUSTRATIVE EMBODIMENTS

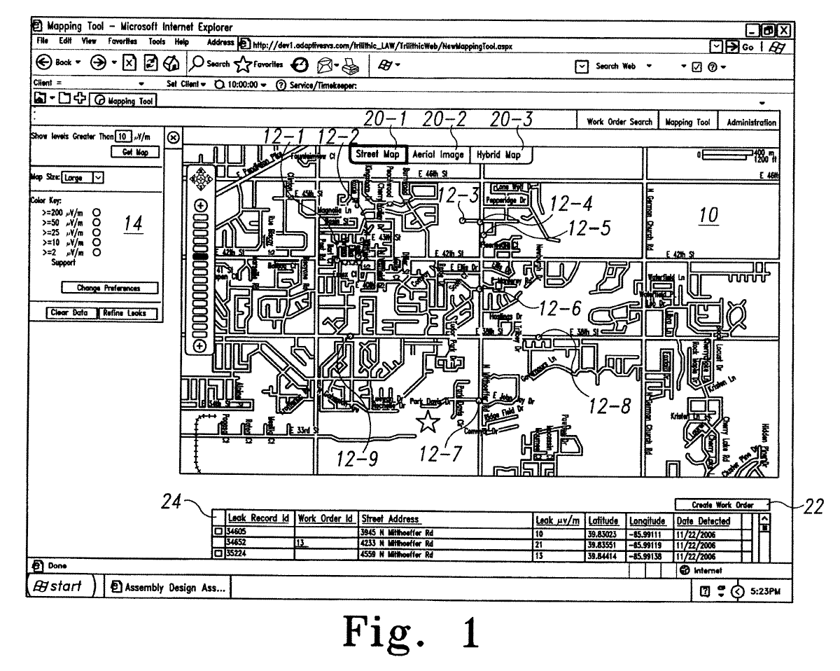

Referring now particularly to FIG. 1, a “Mapquest®”- or “Google®”-style map 10 is displayed on a monitor, with pushpin indicators 12-1, 12-2, . . . 12-n to indicate where leakage above a certain, user-selectable threshold in, for example, microvolts per meter (μV/m) has been detected. The colors of the heads of the pushpin indicators 12-1, 12-2, . . . 12-n indicate various, arbitrarily increasing levels of leakage (see the legend 14 on the left hand side of the monitor display 10), which arbitrary levels can be set by the CATV system operator. See the widgets on legend 14. Such leakage measurements typically will be made by, for example, CATV system employees during their conduct of their daily activities, and uploaded from CATV system employee equipment into a server at a CATV headend to which the operator viewing the display 10 has access. Such activities include, for example, visiting subscriber sites to conduct maintenance and repairs, driving the CATV system to log leakage levels, and so on.

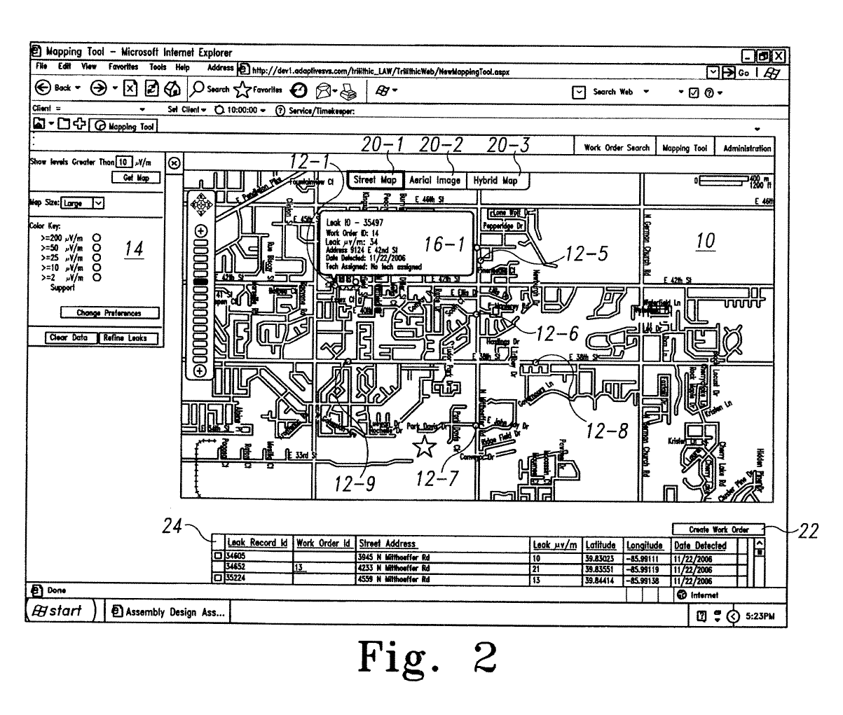

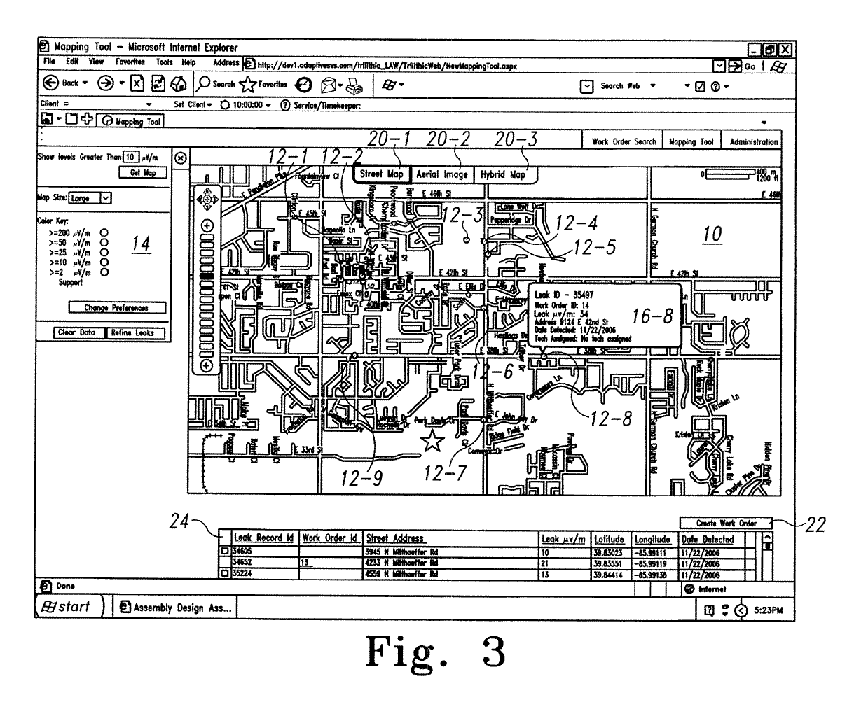

As illustrated in FIGS. 2 and 3, the person viewing the monitor may place the cursor associated with display 10 over a pushpin indicator 12-1, 12-2, . . . 12-n, at which point, a balloon 16-1, 16-2, . . . 16-n, respectively, will be displayed with information concerning the leak which is the subject of the pushpin indicator 12-1, 12-2, . . . 12-n. Such information may include, for example: a CATV system operator's leak identifier, such as a number identifier; whether a work order has been issued to investigate the leak, and if so, a work order number; the strength of the leak, again in μV/m or other suitable dimension; the location, for example, a specific street address, subscriber's name, pole or pedestal number, or the like, of the leak; the date the leak first appeared on the display 10; and, whether a CATV system employee has been assigned to investigate the leak, and if so, some identification, such as the name, employee identification number, or the like, of the employee.

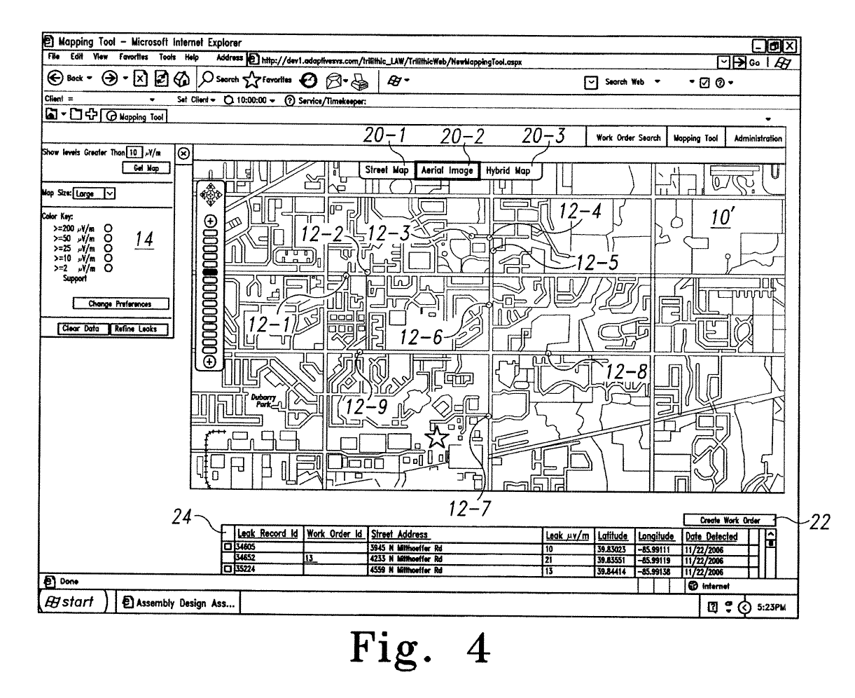

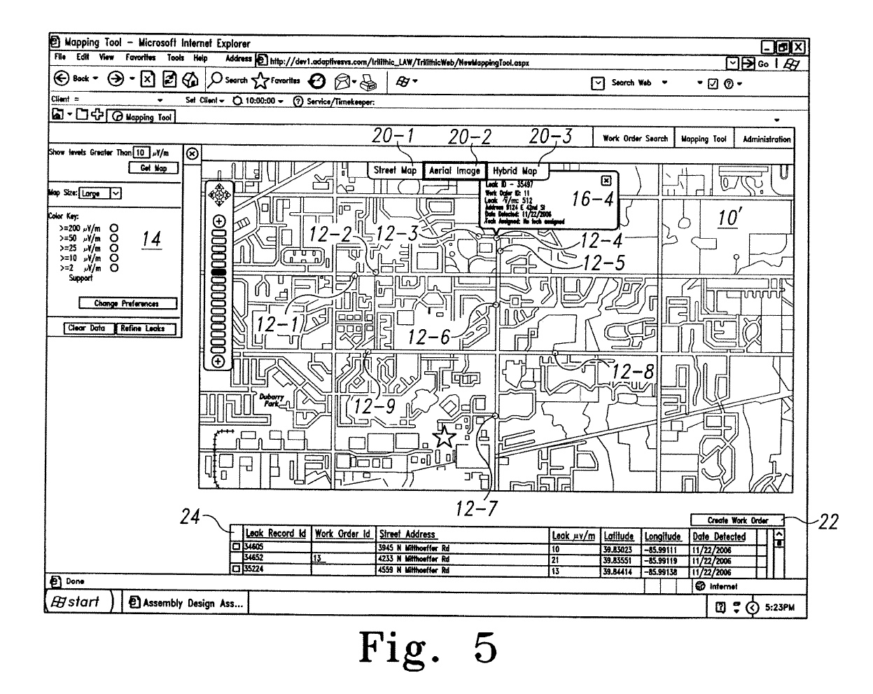

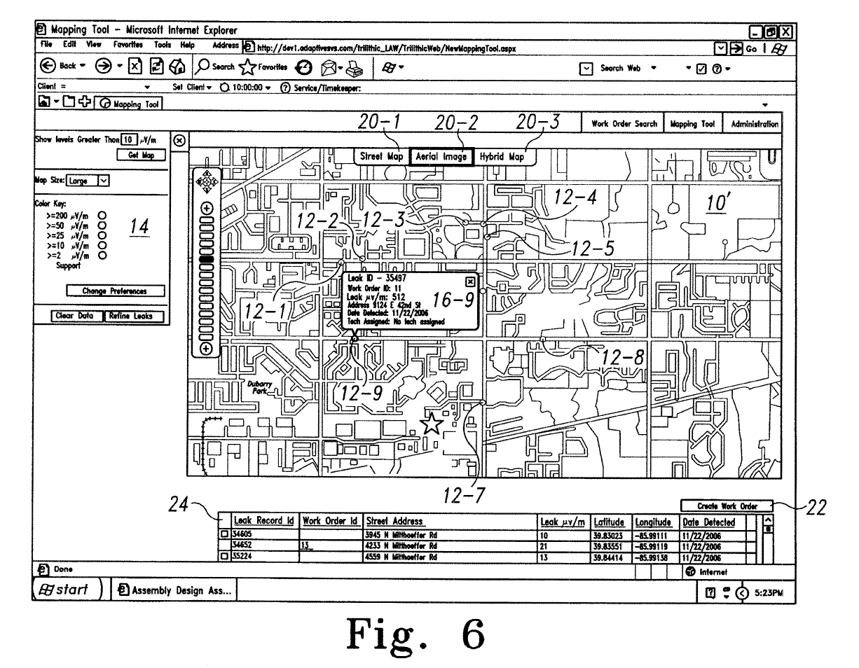

FIGS. 4-6 illustrate aerial map displays 10′ on the monitor, with pushpin indicators 12-1, 12-2, . . . 12-n as noted above. Again, and with reference to FIGS. 5 and 6, the person viewing the monitor may place the cursor over a pushpin indicator 12-1, 12-2, . . . 12-n, at which point, a balloon 16-1, 16-2, . . . 16-n, respectively, will be displayed with information as noted above concerning the leak which is the subject of the pushpin indicator 12-1, 12-2, . . . 12-n.

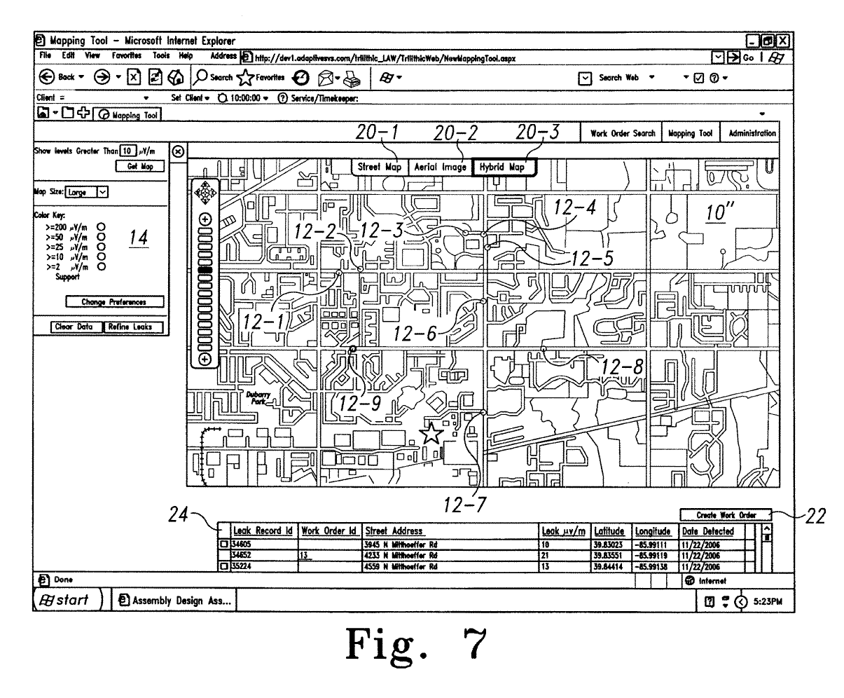

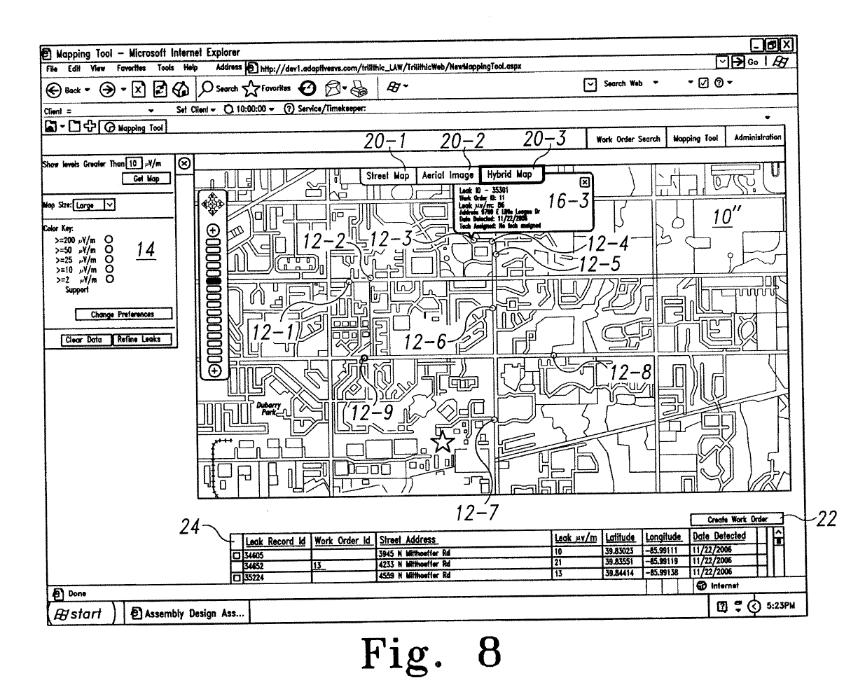

FIGS. 7 and 8 illustrate hybrid “Mapquest®”- or “Google®”-style/aerial map displays 10″ on the monitor, with pushpin indicators 12-1, 12-2, . . . 12-n as noted above. Again, and with reference to FIG. 8, the person viewing the monitor may place the cursor over a pushpin indicator 12-1, 12-2, . . . 12-n, at which point, a balloon 16-1, 16-2, . . . 16-n, respectively, will be displayed with information as noted above concerning the leak which is the subject of the pushpin indicator 12-1, 12-2, . . . 12-n.

The user may select from among views of FIGS. 1-3, 4-6 or 7-8 by clicking, respectively, on the “street map,” “aerial image” or “hybrid map” widgets 20-1, 20-2 or 20-3, respectively, at the tops of the maps 10, 10′, 10″.

Another widget 22 permits the user to generate work orders including such information as: work order ID numbers; detected leakage levels, again in μV/m or other suitable dimension; location, for example, a specific street address, subscriber's name, pole or pedestal number, or the like, of the leak; latitude and longitude of the location; and, the date the leak first appeared on the display 10 by clicking on the pushpin indicator 12-1, 12-2, . . . 12-n and then on the “create work order” widget 22.

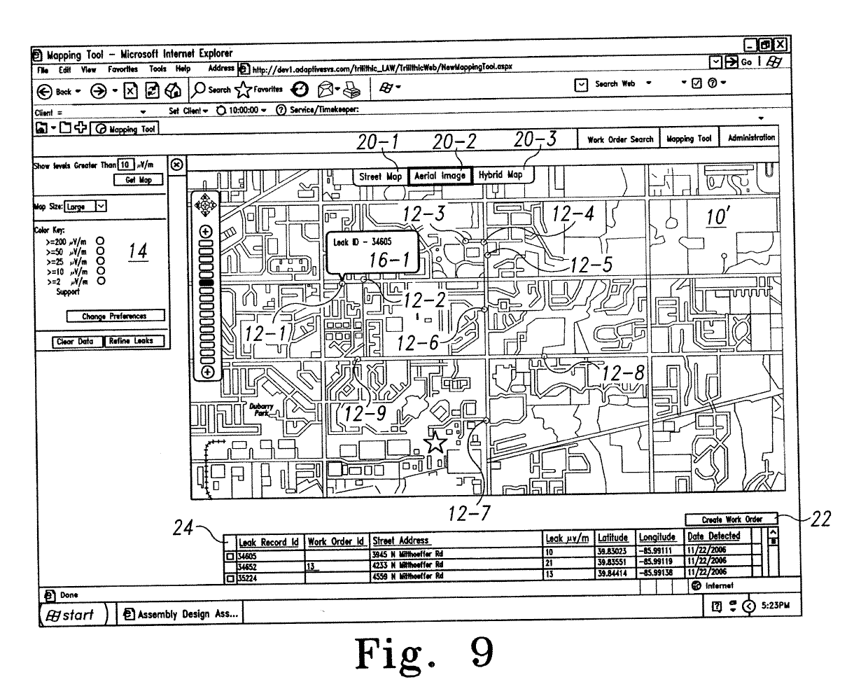

Referring now to FIG. 9, rather than displaying information related to leak strength, location, and related matters in a balloon when the user places a cursor over the associated pushpin indicator 12-1, 12-2, . . . 12-n, the screen can include a table 24 displaying such information. When the user places the cursor over the associated pushpin indicator 12-1, 12-2, . . . 12-n, a leak number or other identifier is displayed in the balloon 16-1, 16-2, . . . 16-n. The user then refers to the leak number or other identifier on the accompanying table 24 and can read the selected information from the table 24, rather than from a balloon 16-1, 16-2, . . . 16-n.

What is claimed is:

1. A method for displaying leakage location and leakage magnitude comprising displaying at least one of an aerial map and a hybrid street/aerial map on a display, displaying on the map icons to indicate where leakage above a certain, user-selectable threshold has been detected, and indicating by a characteristic of the icons selected levels of leakage magnitude.

2. The method of claim 1 further including establishing the selected levels of leakage magnitude.

3. The method of claim 2 further including making leakage measurements, and uploading the leakage measurements into a server to which the operator viewing the display has access.

4. The method of claim 3 further including placing a cursor associated with the display over a selected icon and displaying a balloon including information concerning the leak which is the subject of the icon.

5. The method of claim 4 further including providing on the display a table of variables and placing a cursor associated with the display over a selected icon and displaying a balloon including information includes displaying a balloon including a leak number, the table including the leak number and variables associated with the numbered leak.

6. The method of claim 5 further including providing a widget for permitting an operator to generate a work order to repair the leak represented by the selected icon, the work order number being one of the variables included in the table.

7. The method of claim 1 wherein displaying a map on a display comprises providing a widget for permitting an operator to select a map from among a street map, an aerial map, and a hybrid street/aerial map.

8. The method of claim 1 further including providing a widget for permitting an operator to generate a work order to repair the leak represented by the selected icon.

9. The method of claim 1 further including making leakage measurements, and uploading the leakage measurements into a server to which the operator viewing the display has access.

10. The method of claim 1 further including placing a cursor associated with the display over a selected icon and displaying a balloon including information concerning the leak which is the subject of the icon.

11. The method of claim 10 further including providing on the display a table of variables and placing a cursor associated with the display over a selected icon and displaying a balloon including information includes displaying a balloon including a leak number, the table including the leak number and variables associated with the numbered leak.

12. The method of claim 11 further including providing a widget for permitting an operator to generate a work order to repair the leak represented by the selected icon, the work order number being one of the variables included in the table.
